(19) United States
(12) Patent Application Publication
(10) Pub. No.: US 2007/0072081 A1
(43) Pub. Date: Mar. 29, 2007

(54) Non-aqueous electrolyte secondary battery

(76) Inventors: Hideki Kitao, Kobe-shi (JP); Yoshinori Kida, Kobe-shi (JP)

Correspondence Address: KUBOVCIK & KUBOVCIK, SUITE 710, 900 17TH STREET NW, WASHINGTON, DC, 20006, US

(21) Appl. No.: 11/527,609

(22) Filed: Sep. 27, 2006

(30) Foreign Application Priority Data
Sep. 28, 2005 (JP) 2005-281010
Sep. 21, 2006 (JP) 2006-255720

(51) Int. Cl. H01M 4/50; H01M 4/52; H01M 4/58

(52) U.S. Cl. 429/231.2; 429/223; 429/231.3; 429/221; 429/224

(57) ABSTRACT

A high battery capacity is achieved with a non-aqueous electrolyte secondary battery employing as a positive electrode active material a lithium-containing vanadium oxide containing at least lithium and vanadium. The non-aqueous electrolyte secondary battery includes a positive electrode employing a positive electrode active material that intercalates and deintercalates lithium, a negative electrode employing a negative electrode active material that intercalates and deintercalates lithium, and a non-aqueous electrolyte solution having lithium ion conductivity. The positive electrode active material of the positive electrode includes a first positive electrode active material composed of a lithium-containing vanadium oxide containing at least lithium and vanadium, and a second positive electrode active material containing lithium and at least one element selected from the group consisting of nickel, cobalt, manganese, and iron.

### BACKGROUND OF THE INVENTION

1. Field of the Invention

The present invention relates to a non-aqueous electrolyte secondary battery comprising a positive electrode containing a positive electrode active material that intercalates and deintercalates lithium, a negative electrode containing a negative electrode active material, and a non-aqueous electrolyte solution having lithium ion conductivity. More particularly, the invention relates to a non-aqueous electrolyte secondary battery that employs a lithium-containing vanadium oxide containing at least lithium and vanadium for the positive electrode active material, in which the capacity utilization rate of the lithium-containing vanadium oxide is improved to attain a high battery capacity.

2. Description of Related Art

In recent years, lithium secondary batteries using a non-aqueous electrolyte and performing charge-discharge operations by transferring lithium ions between positive and negative electrodes have been utilized as a new type of high power, high energy density secondary battery.

In the non-aqueous electrolyte secondary batteries, a Li—Co composite oxide that contains cobalt, such as LiCoO₂, is widely used as the positive electrode active material of positive electrodes.

In the non-aqueous electrolyte secondary batteries employing a Li—Co composite oxide, however, the cost of the positive electrode active material tends to be high. For this reason, the use of Li—Mn composite oxides and Li—Ni composite oxides as the positive electrode active material has been researched in recent years.

In recent years, the non-aqueous electrolyte secondary batteries as described above have started to be used for electric automobiles and the like, so demands for non-aqueous electrolyte secondary batteries with higher capacities have been increasing.

With the non-aqueous electrolyte secondary batteries that use a Li—Mn composite oxide or a Li—Ni composite oxide as their positive electrode active material, however, it has been difficult to achieve a high capacity.

In recent years, a non-aqueous electrolyte secondary battery has been proposed that employs vanadium pentoxide, which has a high theoretical capacity, as its positive electrode active material so that the vanadium pentoxide intercalates and deintercalates lithium ions. (See, for example, Japanese Patent No. 3434557.)

Nevertheless, a sufficient battery capacity has not been achieved even with the non-aqueous electrolyte secondary battery that uses vanadium pentoxide as the positive electrode active material.

### BRIEF SUMMARY OF THE INVENTION

Accordingly, it is an object of the present invention to solve the foregoing and other problems in non-aqueous electrolyte secondary batteries. In particular, it is an object of the present invention to improve the capacity utilization rate of the lithium-containing vanadium oxide in a non-aqueous electrolyte secondary battery employing as a positive electrode active material a lithium-containing vanadium oxide such as vanadium pentoxide that intercalates and deintercalates lithium, to obtain a high battery capacity.

The present inventors have investigated the cause of the insufficient battery capacity in the non-aqueous electrolyte secondary battery employing a lithium-containing vanadium oxide, such as vanadium pentoxide, that intercalates and deintercalates lithium as the positive electrode active material. As a consequence, the present inventors have concluded that in the positive electrode active material of this type, a non-crystalline layer of vanadium oxide, which shows low electron conductivity, tends to form easily on the surface, and therefore, conductivity becomes poor in the positive electrode, lowering the battery voltage significantly. Thus, the present invention has been accomplished.

In order to accomplish the foregoing and other objects, the present invention provides a non-aqueous electrolyte secondary battery comprising a positive electrode comprising a positive electrode active material that intercalates and deintercalates lithium; a negative electrode comprising a negative electrode active material that intercalates and deintercalates lithium; and a non-aqueous electrolyte solution having lithium ion conductivity, the positive electrode active material comprising a first positive electrode active material composed of a lithium-containing vanadium oxide containing at least lithium and vanadium, and a second positive electrode active material containing lithium and at least one element selected from the group consisting of nickel, cobalt, manganese and iron.

The non-aqueous electrolyte secondary battery according to the present invention employs, as its positive electrode active material, a first positive electrode active material composed of a lithium-containing vanadium oxide containing at least lithium and vanadium, and a second positive electrode active material containing lithium and at least one element selected from the group consisting of nickel, cobalt, manganese, and iron. Therefore, unlike the case of using only a lithium-containing vanadium oxide as the positive electrode active material, an abrupt decrease in the battery voltage is prevented and the capacity utilization rate of the lithium-containing vanadium oxide is improved. Thus, a high battery capacity can be obtained. In particular, when the second positive electrode active material has a higher average discharge potential than the average discharge potential of the first positive electrode active material, an abrupt decrease in the battery voltage is prevented more effectively, and thus, an even higher battery capacity can be obtained.

### BRIEF DESCRIPTION OF THE DRAWINGS

FIG. 1 is a schematic illustrative drawing of the test cell used for studying the characteristics of Examples and Comparative Examples of this invention;

FIG. 2 is a graph showing the discharge curves of the test cells of Example 1 as well as Comparative Examples 1 and 2, at the first charge-discharge cycle; and

FIG. 3 is a graph showing the discharge curves of the test cells of Example 2 as well as Comparative Examples 1 and 3, at the first charge-discharge cycle.

### DETAILED DESCRIPTION OF THE INVENTION

Hereinbelow, the non-aqueous electrolyte secondary battery according to the present invention is described in further detail based on preferred embodiments thereof. It should be construed, however, that the non-aqueous electrolyte secondary battery according to the present invention is not limited to the following preferred embodiments but various changes and modifications are possible without departing from the scope of the invention.

In the non-aqueous electrolyte secondary battery according to the present invention, examples of the lithium-containing vanadium oxide containing at least lithium and vanadium of the first positive electrode active material in the positive electrode include LiV₂O₅, LiV₃O₈, Li₃V₂(PO)₃, LiVPO₄, and LiMVO₄ where M is an element selected from Be, Mg, Co, Ni, Zn, Cd, Mn, and Fe.

Examples of the second positive electrode active material containing lithium and at least one element selected from the group consisting of nickel, cobalt, manganese and iron, used for the positive electrode, include: LiFePO₄; LiₐNiₚMn_{q}CoᵣO₂ where 1≦a≦1.5, p+q+r≦1, 0≦r≦1, 0≦p≦1, and 0≦q≦1; LiMn₂O₄; LiCoPO₄; LiFeP₂O₇; LiFe_{1.5}P₂O₇; and LiNi_{1.5}P₂O₇. Preferable examples are the just-mentioned LiFePO₄ and LiₐNiₚMn_{q}CoᵣO₂.

Herein, if the first and second positive electrode active materials have too small particle sizes and accordingly too large BET specific surface areas, the active materials are not dispersed uniformly with the conductive agent, thereby increasing resistance. On the other hand, if their particle sizes are too large and the BET specific surface areas are too small, the resistances of the positive electrode active materials themselves become too high. Therefore, it is preferable that the positive electrode active materials have a volume average particle size D50 of from 0.1 μm to 20 μm, and a BET specific surface area of from 0.1 m²/g to 20 m²/g. It should be noted that the volume average particle size D50 is a volume particle size at which the cumulative frequency is 50% in cumulative distribution function of volume particle size.

In using the first positive electrode active material and the second positive electrode active material as the positive electrode active materials, if the amount of the second positive electrode active material is too small, the effect of increasing the battery voltage will not be attained sufficiently and the battery capacity will be lowered. On the other hand, if the amount of the second positive electrode active material is too large, the amount of the first positive electrode active material, which has a high theoretical capacity, becomes relatively small. Therefore, a high battery capacity will not be obtained. For this reason, the first positive electrode active material and the second positive electrode active material are mixed at a weight ratio of from 9:1 to 1:9, and more preferably, at a weight ratio of from 6:4 to 4:6.

In the non-aqueous electrolyte secondary battery according to the present invention, any known non-aqueous solvent that has been conventionally used for non-aqueous electrolyte secondary batteries may be employed as the non-aqueous solvent for the non-aqueous electrolyte solution. Examples of the non-aqueous solvent include cyclic carbonates such as ethylene carbonate, propylene carbonate, butylene carbonate, and vinylene carbonate; and chain carbonates such as dimethyl carbonate, methyl ethyl carbonate, and diethyl carbonate. A mixed solvent in which a cyclic carbonate and a chain carbonate are mixed is particularly preferable from the standpoint of stability and ion conductivity of the non-aqueous electrolyte solution.

In the non-aqueous electrolyte, any known solute that has conventionally been used for non-aqueous electrolyte secondary batteries may be employed as a solute to be dissolved in the just-noted non-aqueous solvent. Examples include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, and mixtures thereof. In order to improve the cycle performance of the non-aqueous electrolyte secondary battery, it is preferable that the solute contain a lithium salt having an oxalato complex as anions, and more preferably lithium-bis(oxalato)borate.

In the non-aqueous electrolyte secondary battery of the present invention, the negative electrode active material used for the negative electrode may be any known negative electrode active material that has been conventionally used for non-aqueous electrolyte secondary batteries. In order to enhance the energy density and battery voltage of the non-aqueous electrolyte secondary battery, it is preferable to use a carbon material.

### EXAMPLES

Next, examples of the non-aqueous electrolyte secondary battery according to the present invention are described in detail along with comparative examples, and it will be demonstrated that the examples of the non-aqueous electrolyte secondary battery exhibit improved battery capacities. It should be construed that the present invention is not limited to batteries shown in the following examples, and various changes and modifications are possible without departing from the scope of the invention.

### Example 1

In Example 1, a positive electrode was prepared in the following manner. LiV₂O₅ having a BET specific surface area of 1 m²/g and a volume average particle size D50 of 10 μm was used as a lithium-containing vanadium oxide, serving as a first positive electrode active material. Li_{1.15}Ni_{0.4}Co_{0.3}Mn_{0.3}O₂ having a BET specific surface area of 0.5 m²/g an a volume average particle size D50 of 10 μm was used as a second positive electrode active material. The first positive electrode active material and the second positive electrode active material were mixed together at a weight ratio of 5:5. The resultant mixture was used as a positive electrode active material.

The positive electrode active material thus prepared was kneaded with a solution in which particulate carbon made of acetylene black, serving as a conductive agent, and polyvinylidene fluoride, serving as a binder agent, were dissolved in N-methyl-2-pyrrolidone so that the weight ratio of the positive electrode active material, the conductive agent, and the binder agent was 90:5:5, to thus prepare a positive electrode slurry. The resultant positive electrode slurry was applied onto a current collector made of an aluminum foil and then dried. Thereafter, the resultant current collector was pressure-rolled with pressure rollers. Thus, the positive electrode was prepared.

### Example 2

In Example 2, a positive electrode was prepared in the same manner as in Example 1 above, except that LiFePO₄ having a BET specific surface area of 10 m²/g and a volume average particle size D50 of 2 μm was used as the second positive electrode active material in the positive electrode.

### Comparative Example 1

In Comparative Example 1, a positive electrode was prepared in the same manner as in Example 1 above, except that only LiV₂O₅ having a BET specific surface area of 1 m²/g and a volume average particle size D50 of 10 μm was used as the positive electrode active material in the positive electrode.

### Comparative Example 2

In Comparative Example 2, a positive electrode was prepared in the same manner as in Example 1 above, except that only Li_{1.15}Ni_{0.4}Co_{0.3}Mn_{0.3}O₂ having a BET specific surface area of 0.5 m²/g an a volume average particle size D50 of 10 μm was used as the positive electrode active material in the positive electrode.

### Comparative Example 3

In Comparative Example 3, a positive electrode was prepared in the same manner as in Example 1 above, except that only LiFePO₄ having a BET specific surface area of 10 m²/g and a volume average particle size D50 of 2 μm was used as the positive electrode active material in the positive electrode.

### Comparative Example 4

In Comparative Example 4, a positive electrode was prepared in the same manner as in Example 1 above, except that a 5:5 weight ratio mixture of Li_{1.15}Ni_{0.4}Co_{0.3}Mn_{0.3}O₂ having a BET specific surface area of 0.5 m²/g an a volume average particle size D50 of 10 μm and LiFePO₄ having a BET specific surface area of 10 m²/g and a volume average particle size D50 of 2 μm was used as the positive electrode active material in the positive electrode.

Then, test cells 10 as illustrated in FIG. 1 were prepared using as their working electrodes 11 the positive electrodes prepared in the manners shown in the just-described Examples 1, 2 and Comparative Examples 1 to 4.

Here, each of the test cells 10 included a non-aqueous electrolyte solution 14, a counter electrode 12, serving as the negative electrode, and a reference electrode 13. The non-aqueous electrolyte solution 14 was prepared by dissolving lithium hexafluorophosphate (LiPF₆) at a concentration of 1 mol/L into a mixed solvent of 3:7 volume ratio of ethylene carbonate (EC) and diethyl carbonate (DEC). Metallic lithium was used for both the counter electrode 12 and the reference electrode 13.

The non-aqueous electrolyte solution 14 was filled in each of the test cells 10, and each respective working electrode 11 prepared as described above, the counter electrode 12 serving as the negative electrode, and the reference electrode 13 were immersed in the non-aqueous electrolyte solution 14.

Next, the test cells 10 were charged with a constant current of 1 mA at room temperature until the potential of the working electrode 11 with respect to the reference electrode 13 became 4.30 V in each of the test cells 10, and then they were rested for 10 minutes. Thereafter, the cells were discharged at a constant current of 1 mA until the potential of the working electrode 11 with respect to the reference electrode 13 became 2.00 V. Thus, discharge capacity per 1 g of positive electrode active material (mAh/g) at the first cycle was obtained for each of the test cells 10. The results are shown in Table 1 below.

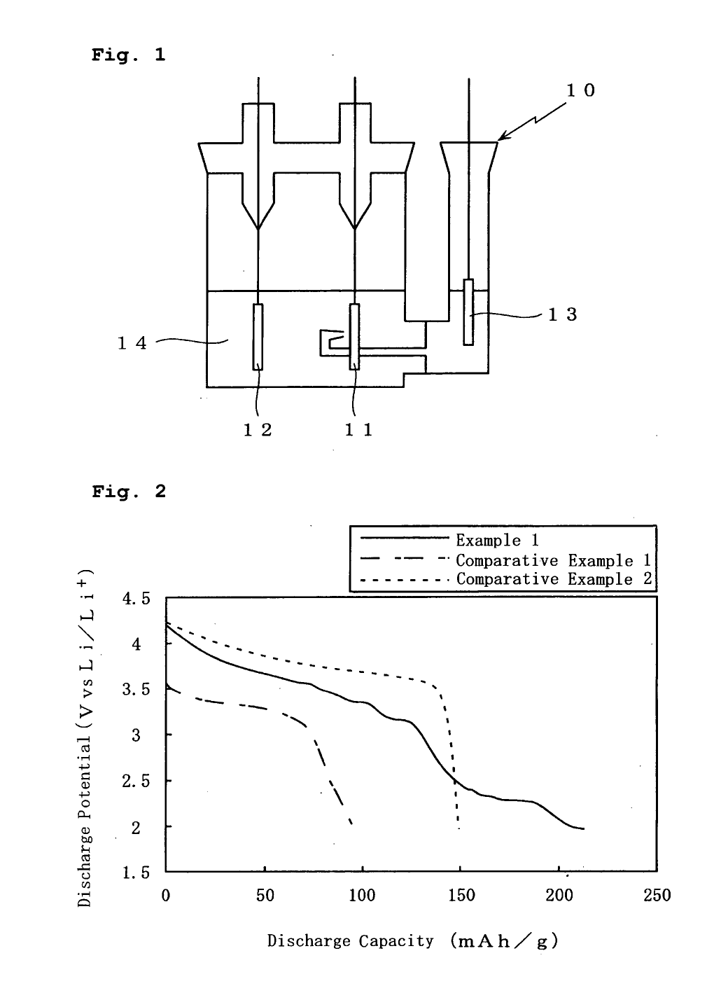

The discharge curves of the test cells that use positive electrodes prepared as described in the foregoing Example 1 and Comparative Examples 1 and 2 are shown in FIG. 2. In the graph, the discharge curve of the test cell that uses the positive electrode in accordance with Example 1 is represented by the solid line, the discharge curve of the test cell that uses the positive electrode in accordance with Comparative Example 1 is represented by the dot-dashed line, and the discharge curve of the test cell that uses the positive electrode in accordance with Comparative Example 2 is represented by the dashed line.

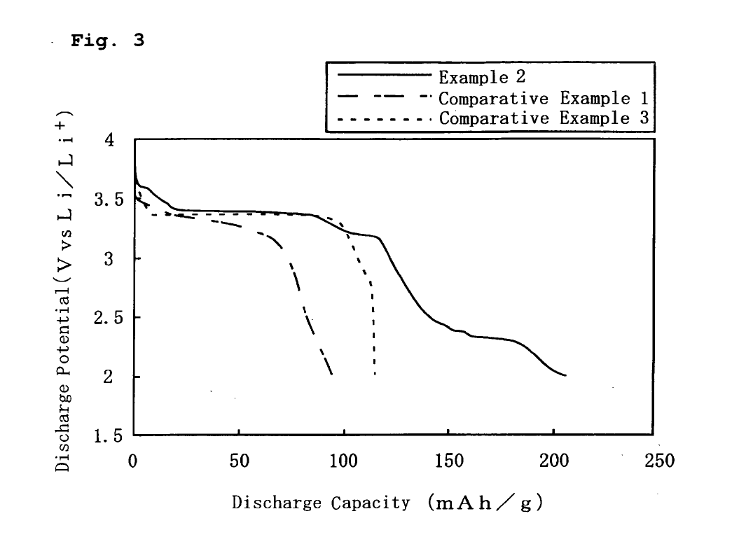

Likewise, the discharge curves of the test cells that use the positive electrodes prepared as described in the foregoing Example 2 and Comparative Examples 1 and 3 are shown in FIG. 3. In the graph, the discharge curve of the test cell that uses the positive electrode in accordance with Example 2 is represented by the solid line, the discharge curve of the test cell that uses the positive electrode in accordance with Comparative Example 1 is represented by the dot-dashed line, and the discharge curve of the test cell that uses the positive electrode in accordance with Comparative Example 3 is represented by the dashed line.

An average discharge potential of the test cells using the positive electrodes prepared as described in Comparative Examples 1-3 was measured using the respective discharge curves. The results are shown in Table 1.

TABLE 1

| | | | Average |
|---|---|---|---|
| | | | Discharge |
| | Positive electrode | Discharge | Potential |
| | active material | capacity | (V vs. |
| | (weight ratio) | (mAh/g) | Li/Li⁺) |
| Example 1 | LiV₂O₅ + Li_{1.15}Ni_{0.4}Co_{0.3} | 212 | — |
| | Mn_{0.3}O₂ (5:5) | | |
| Example 2 | LiV₂O₅ + LiFePO₄ (5:5) | 206 | — |
| Comparative | LiV₂O₅ | 94 | 2.8 |
| Example 1 | | | |
| Comparative | Li_{1.15}Ni_{0.4}Co_{0.3}Mn_{0.3}O₂ | 150 | 3.7 |
| Example 2 | | | |
| Comparative | LiFePO₄ | 115 | 3.3 |
| Example 3 | | | |
| Comparative | LiFePO₄ + Li_{1.15}Ni_{0.4}Co_{0.3} | 126 | — |
| Example 4 | Mn_{0.3}O₂ (5:5) | | |

The results show that the average discharge potential of the second positive electrode active material comprising Li_{1.15}Ni_{0.4}Co_{0.3}Mn_{0.3}O₂ or LiFePO₄ was higher than that of the first positive electrode active material comprising a lithium-containing vanadium oxide, LiV₂O₅.

The results clearly demonstrates that the test cells of Examples 1 and 2, which used the positive electrode active material comprising the first positive electrode active material composed of a lithium-containing vanadium oxide LiV₂O₅ and the second positive electrode active material composed of Li_{1.15}Ni_{0.4}Co_{0.3}Mn_{0.3}O₂ or LiFePO₄ in the positive electrode, exhibited significant improvements in discharge capacity over the test cells of Comparative Example 1, which used the first positive electrode active material LiV₂O₅ alone, Comparative Examples 2 and 3, which used only the second positive electrode active materials Li_{1.15}Ni_{0.4}Co_{0.3}Mn_{0.3}O₂ and LiFePO₄ alone, and Comparative Example 4, which used a mixture of the second positive electrode active materials Li_{1.15}Ni_{0.4}Co_{0.3}Mn₃O₂ and LiFePO₄.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application Nos. 2005-281010 and 2006-255720 filed Sep. 28, 2005, and Sep. 21, 2006, respectively, which are incorporated herein by reference.

What is claimed is:

1. A non-aqueous electrolyte secondary battery comprising:
a positive electrode comprising a positive electrode active material that intercalates and deintercalates lithium;
a negative electrode comprising a negative electrode active material that intercalates and deintercalates lithium; and
a non-aqueous electrolyte solution having lithium ion conductivity,
the positive electrode active material comprising a first positive electrode active material composed of a lithium-containing vanadium oxide containing at least lithium and vanadium, and a second positive electrode active material containing lithium and at least one element selected from the group consisting of nickel, cobalt, manganese and iron.

2. The non-aqueous electrolyte secondary battery according to claim 1, wherein the second positive electrode active material contains at least one material selected from the group consisting of: LiFePO₄; LiₐNiₚMn_{q}CoᵣO₂, where 1≦a≦1.5, p+q+r≦1, 0≦r≦1, 0≦p≦1, and 0≦q≦1; LiMn₂O₄; LiCoPO₄; LiFeP₂O₇; LiFe_{1.5}P₂O₇; and LiNi_{1.5}P₂O₇.

3. The non-aqueous electrolyte secondary battery according to claim 1, wherein the second positive electrode active material has a higher average discharge potential than the average discharge potential of the first positive electrode active material.

4. The non-aqueous electrolyte secondary battery according to claim 1, wherein the first positive electrode active material and the second positive electrode active material are mixed in a weight ratio of from 6:4 to 4:6.

5. The non-aqueous electrolyte secondary battery according to claim 2, wherein the second positive electrode active material has a higher average discharge potential than the average discharge potential of the first positive electrode active material.

6. The non-aqueous electrolyte secondary battery according to claim 2, wherein the first positive electrode active material and the second positive electrode active material are mixed in a weight ratio of from 6:4 to 4:6.

7. The non-aqueous electrolyte secondary battery according to claim 3, wherein the first positive electrode active material and the second positive electrode active material are mixed in a weight ratio of from 6:4 to 4:6.

8. The non-aqueous electrolyte secondary battery according to claim 5, wherein the first positive electrode active material and the second positive electrode active material are mixed in a weight ratio of from 6:4 to 4:6.
